(19) United States
(12) Patent Application Publication
(10) Pub. No.: US 2024/0004033 A1
(43) Pub. Date: Jan. 4, 2024

(54) LIGHT SENSOR AND CONTROL METHOD THEREOF

(71) Applicant: SENSORTEK TECHNOLOGY CORP., Hsinchu County (TW)

(72) Inventors: Han-Chung Hsu, Hsinchu County (TW); Feng-Jung Hsu, Hsinchu County (TW)

(21) Appl. No.: 18/100,734

(22) Filed: Jan. 24, 2023

Related U.S. Application Data
(60) Provisional application No. 63/267,066, filed on Jan. 24, 2022.

(51) Int. Cl. G01S 7/48; G01S 17/08; G01S 7/481

(52) U.S. Cl. CPC G01S 7/4802; G01S 7/4815; G01S 17/08

(57) ABSTRACT

A light sensor and a control method thereof are revealed. The light sensor comprises a first light-emitting element, a second light-emitting element and a light-sensing element. The first light-emitting element is used to generate a first emitting signal. The first emitting signal has an optical wavelength within a first wavelength range. The second light-emitting element is used to generate a second emitting signal. The wavelength of the second emitting signal has an optical wavelength within a second wavelength range. The first wavelength range is different from the second wavelength range. Thereby, a control circuit sequentially controls the first light-emitting element and the second light emitting-element to emit the first emitting signal and the second emitting signal. When the first emitting signal and the second emitting signal are reflected by an object and received by the light-sensing element, the control circuit may determine the type of the object based on the signal sensed by the light-sensing element.

### FIELD OF THE INVENTION

The present application is related to a light sensor and a control method thereof, in particular to a light sensor and a control method thereof for detecting the proximity and the type of an object.

### BACKGROUND OF THE INVENTION

Light sensors using light sensing technology are applied extensively to many applications. For example, a proximity sensor may be used to detect the distance between an object and an electronic device, such as a smartphone or wireless Bluetooth earphones. Thereby, when the proximity sensor is close to a user's face, the smartphone may shut off the display and touch functions correspondingly for avoiding interruption due to unintentional touches. In addition, when the proximity sensor is away from a user's face, the earphones may be shut off for saving power.

In general, current proximity sensors usually adopt light-emitting diodes or laser diodes for emitting light. When the light emit to an approaching object, the intensity of the reflection light is used to judge the distance to the object. Unfortunately, the light intensity cannot be used to judge the type of objects directly. To do so, for example, to judge if the human skin is approaching, additional sensors should be used to provide more information. By using a capacitance sensor or a temperature sensor, a system may further judge if the approaching object is human skin. Nonetheless, this method requires additional sensors and increases the overall cost. Thereby, most commercial electronic devices do not identify the type of approaching objects.

Accordingly, light sensors indeed should be improved so that electronic devices may be implemented with more accuracy and more various control functions in lower costs.

### SUMMARY OF THE INVENTION

An objective of the present application is to provide a light sensor and the control method thereof. By disposing a plurality of light-emitting elements with wavelengths corresponding to different wavelength ranges and controlling the operation of the plurality of light-emitting elements sequentially, the type of an object may be judged according to the differences between the signals sensed by a light-sensing element.

The present application provides a light sensor, which comprises a first light-emitting element, a second light-emitting element, and a light-sensing element. The first light-emitting element generates a first emitting signal with wavelengths within a first wavelength range. The second light-emitting element generates a second emitting signal with wavelengths within a second wavelength range. The first wavelength range is different from the second wavelength range. A control circuit controls the first light-emitting element and the second light-emitting element sequentially to emit the first emitting signal and the second emitting signal. When the first emitting signal and the second emitting signal are reflected by an object and received by the light-sensing element, the control circuit judges the type of the object according to the signal sensed by the light-sensing element.

The present application provides a control method for a light sensor, which controls the operation of a first light-emitting element, a second light-emitting element, and a light-sensing element. The first light-emitting element emits light with wavelengths within a first wavelength range. The second light-emitting element emits light with wavelengths within a second wavelength range. The first wavelength range is different from the second wavelength range. A control circuit controls the first light-emitting element and the second light-emitting element sequentially to emit light and the control circuit receives the signal sensed by the light-sensing element. When the light emitted by the first light-emitting element and the second light-emitting element is reflected by an object and received by the light-sensing element, the control circuit judges the type of the object according to the signal sensed by the light-sensing element.

### BRIEF DESCRIPTION OF DRAWINGS

FIG. 1 shows a schematic diagram of the architecture of the light sensor and the control method thereof according to an embodiment of the present application;

FIG. 2 shows a schematic diagram of the wavelength response of the light sensor and the control method thereof according to an embodiment of the present application;

FIG. 3A shows the identification result for various objects under test using the first light-emitting element combination according to an embodiment of the present application;

FIG. 3B shows the identification result for various objects under test using the second light-emitting element combination according to an embodiment of the present application; and

FIG. 3C shows the identification result for various objects under test using the third light-emitting element combination according to an embodiment of the present application.

### DETAILED DESCRIPTION OF THE INVENTION

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other devices or connecting means indirectly.

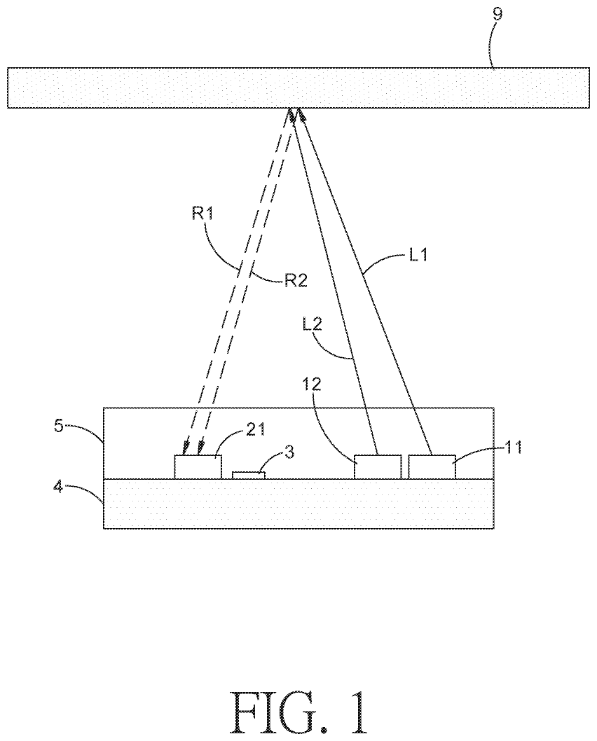

Please refer to FIG. 1, which shows a schematic diagram of the architecture of the light sensor and the control method thereof according to an embodiment of the present application. The light sensor comprises a first light-emitting element 11, a second light-emitting element 12, and a light-sensing element 21. The first light-emitting element 11 emits a first emitting signal L1 with wavelengths within a first wavelength range. The second light-emitting element 12 emits a second emitting signal L2 with wavelengths within a second wavelength range. The first wavelength range is different from the second wavelength range. For convenience, the light-emitting element emitting light with a shorter wavelength is the first light-emitting element 11. In other words, the peak wavelength of the first wavelength range is shorter than the peak wavelength of the second wavelength range.

To elaborate, the first light-emitting element 11 and the second light-emitting element 12 are usually light-emitting diodes or laser diodes. To correspond the wavelengths of the first light-emitting element 11 and the second light-emitting element 12 to different wavelength ranges, devices with different light-emitting characteristics may be selected. For example, two light-emitting diodes with a short and a long peak wavelength, respectively, may be selected to be the first light-emitting element 11 and the second light-emitting element 12. In practice, there are many types of light-emitting diodes and laser diodes. A person having ordinary skill in the art may easily select devices with different wavelengths to form the first light-emitting element 11 and the second light-emitting element 12.

Considering component unification or other concerns, if only one type of device may be used to fabricate the first light-emitting element 11 and the second light-emitting element 12, methods such as including optical filters still may be adopted to correspond the wavelengths of the first light-emitting element 11 and the second light-emitting element 12 to different wavelength ranges. Thereby, the present application does not limit how to fabricate the first light-emitting element 11 and the second light-emitting element 12.

According to the present embodiment, the light sensor may further comprise a control circuit 3. The control circuit 3 may be coupled to the first light-emitting element 11, the second light-emitting element 12, and the light-sensing element 21, respectively, for controlling their operations and processing the sensing signal generated by the light-sensing element 21. The light-sensing element 21 and the control circuit 3 are generally integrated on an integrated circuit (IC) chip. Nonetheless, according to another embodiment of the present application, an external control circuit may be used to control the first light-emitting element 11, the second light-emitting element 12, and the light-sensing element 21 and process signals. In this case, the control circuit may be disposed in an external system, for example, a mobile communication device or a wearable device.

The first light-emitting element 11, the second light-emitting element 12, the light-sensing element 21, and the control circuit 3 may be disposed on a substrate 4. In addition, a transparent molded material 5 may be used to package and protect the chips of the first light-emitting element 11, the second light-emitting element 12, the light-sensing element 21, and the control circuit 3. These are normal structures adopted by proximity sensors. Nonetheless, the present application is not limited to the structures.

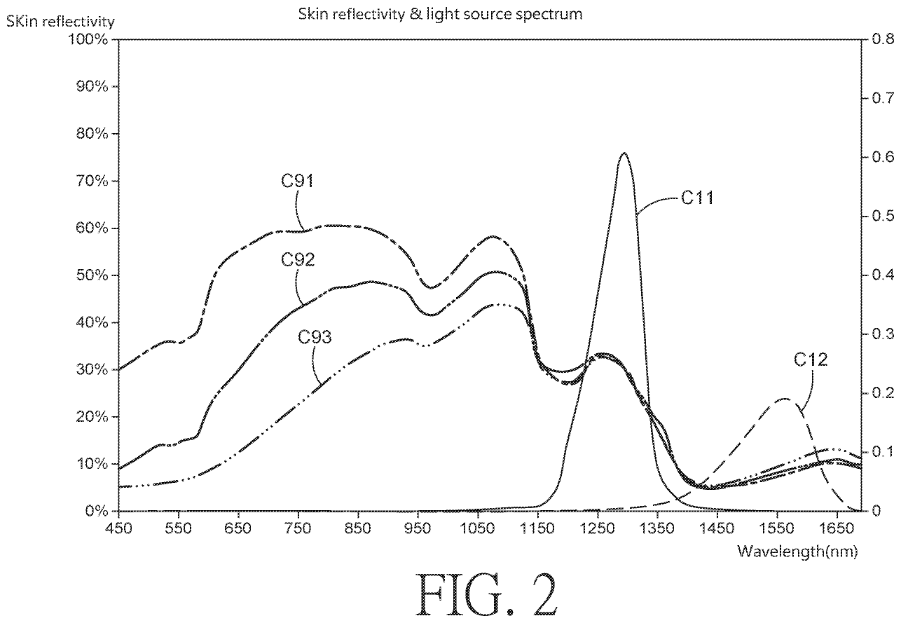

Please refer to FIG. 2, which shows a schematic diagram of the wavelength response of the light sensor and the control method thereof according to an embodiment of the present application. The curve C11 represents the first emitting signal L1 emitted by the first light-emitting element 11; the curve C12 represents the second emitting signal L2 emitted by the second light-emitting element 12. When an object 9 approaches the light sensor, the first emitting signal L1 generated by the first light-emitting element 11 will be reflected by the object 9 and forming a first reflection signal R1 to be received by the light-sensing element 21; the second emitting signal L2 generated by the second light-emitting element 12 will be reflected by the object 9 and forming a second reflection signal R2 to be received by the light-sensing element 21. According to the embodiment of the present application, the distance sensing may be performed according to the first reflection signal R1 or the second reflection signal R2 sensed by the light-sensing element 21. In other words, the control circuit 3 may sense distance using the first reflection signal R1 sensed by the light-sensing element 21 independently. Alternatively, the control circuit 3 may sense distance using the second reflection signal R2 sensed by the light-sensing element 21 independently. Alternatively, the distance sensing may be calculated by combining the first reflection signal R1 and the second reflection signal R2 sensed by the light-sensing element 21. Since distance sensing is an existing function in the proximity sensors according to the prior art, the operation details will not be described here.

It should be noted that how the embodiment according to the present application judges the type of the object 9 according to the signal sensed by the light-sensing element 21. In general, the intensity of the reflection light sensed by the light-sensing element 21 cannot be used directly to judge the type of the object 9. This is because the intensity of the sensing signal, no matter the first reflection signal R1 or the second reflection signal R2, will be regarded as the result of the distance to the object 9. Nonetheless, according to the present embodiment, the control circuit 3 controls the operations of the first light-emitting element 11 and the second light-emitting element 12 sequentially to make them emit the first emitting signal L1 and the second emitting signal L2 (or the reverse order) sequentially in a short time. It should be noted that the “sequentially” described here, the other part of the present specification, and the claim means that the first light-emitting element 11 and the second light-emitting element 12 operate in the predetermined order. Whether the first light-emitting element 11 emits the first emitting signal L1 first or the second light-emitting element 12 emits the second emitting signal L2 first will not influence the operations of the present application. Hence, the order is not to limit the scope of the present application.

Since the first light-emitting element 11 and the second light-emitting element 12 may emit the first emitting signal L1 and the second emitting signal L2 alternately in a short time, in most cases, the relative positions of the object 9 and the light sensor do not change. Nonetheless, because the first wavelength range of the first emitting signal L1 is lower than the second wavelength range of the second emitting signal L2, the first reflection signal R1 and the second reflection signal R2 sensed by the light-sensing element 21 will be affected. To elaborate, the reflectivity of the object 9 will be different for different wavelengths. For example, the light absorptivity of water is higher in the wavelengths around 900˜1000 nm. Thereby, if objects contain different amount of water, the reflectivity in this wavelength range will be different. The above is only a simple description. In practice, the factors influencing the reflectivity is not only water content. To know the reflectivity of various objects for different wavelengths, a person having ordinary skill in the art may acquire the information through limited number of experiments.

For example, assuming in a practical application, the light sensor and the control method thereof are used to identify if the object 9 approaching is human skin. First, the reflection characteristics of the object to be identified may be induced. FIG. 2 shows reflectivity curves C91, C92, C93 for light, medium, and dark skin samples, respectively. Since these three skin samples are the targets to be identified, the first and second wavelength ranges should preferably avoid the regions of proximate reflectivity with these samples. For example, for the curve C91 for the light skin sample, it is observed that the reflectivity and slope are similar around 650 nm and 1050 nm. Then the first and second wavelength ranges should preferably avoid this combination. Otherwise, even though other skin samples may be identified, the light skin sample might not be identified.

In other words, if the relative positions of the object 9 and the light sensor is fixed and the first reflection signal R1 and the second reflection signal R2 sensed by the light-sensing signal 21 are different, then the difference might be caused by the type of the object 9. By using different reflectivity for different wavelengths by the object as well as the different wavelength ranges corresponding to the first light-emitting element 21 and the second light-emitting element 12, the light-sensing element 21 may judge the type of the object according to the first reflection light R1 and the second reflection light R2 sensed sequentially. To elaborate, in practice, the first and second wavelength ranges may be determined by the following experiment.

First, the control circuit 3 may produce an identification rate K according to the difference between the first reflection signal R1 and the second reflection signal R2 sensed sequentially by the light-sensing signal 21. If the value of the first reflection signal R1 sensed by the light-sensing element 21 after analog-to-digital conversion is Code_11 and the value of the second reflection signal R2 sensed by the light-sensing element 21 after analog-to-digital conversion is Code_12, the above identification rate K may be simply defined as the ratio between Code_11 and Code_12. Nonetheless, to enlarge the difference for various objects, users may redefine the identification rate K by, for example, multiplying specific coefficients or arithmetic operations. For a simple example, the identification rate K may be defined as the following equation (1):

$$K = \frac{Code\_ 11 - Code\_ 12}{Code\_ 11 + Code\_ 12} \times 100 \% \qquad ( 1 )$$

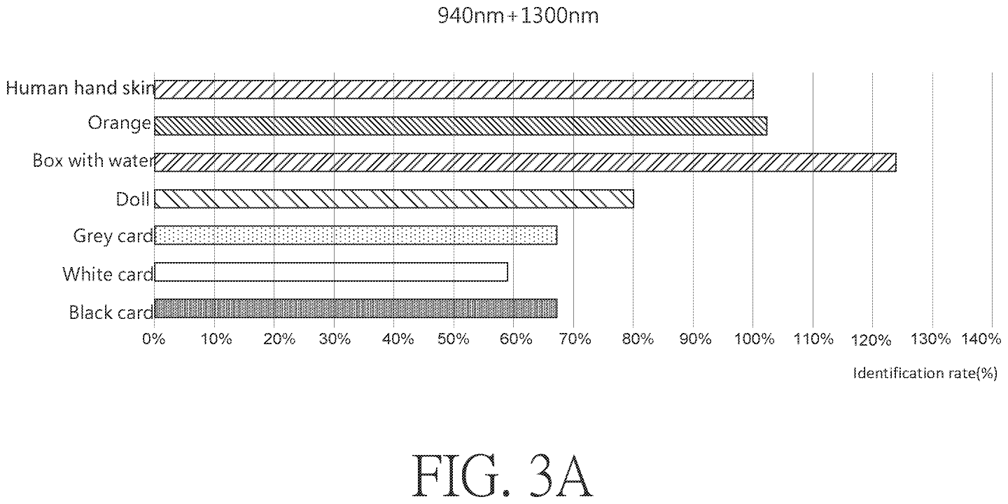

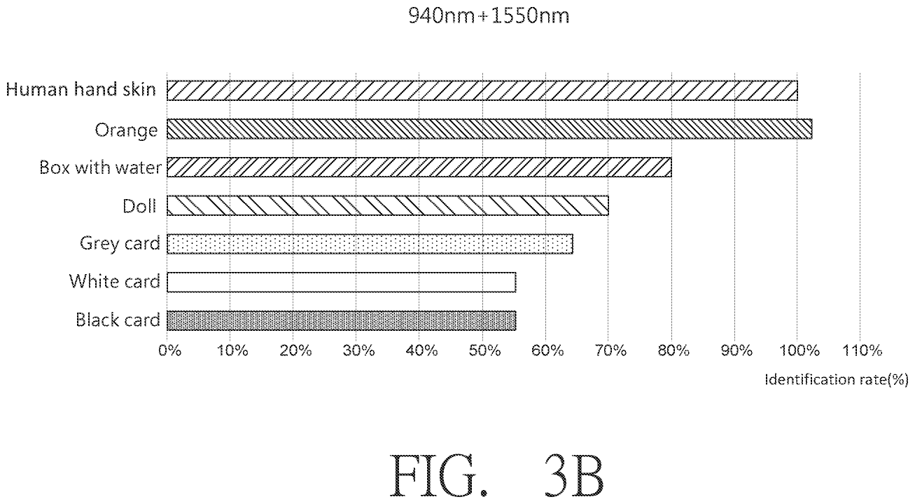

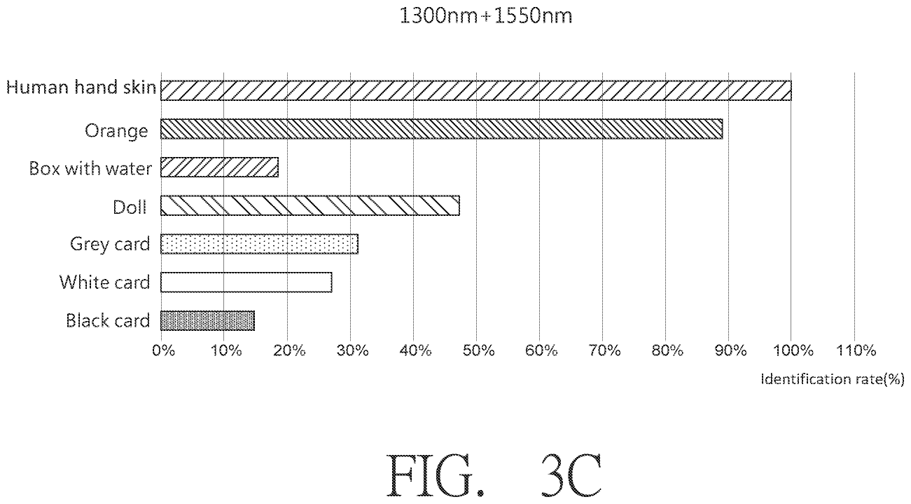

Next, several objects under test are selected, including the target object sample (for example, the human hand skin) and other compare object samples. At the identical relative positions and ambient conditions, the results are shown in FIGS. 3A, 3B, and 3C. In FIG. 3A, the peak wavelength of the first light-emitting element 11 is selected to be 940 nm and the peak wavelength of the second light-emitting element 12 is selected to be 1300 nm. According to the figure, it may be observed that the identification rates K for the orange and the human hand skin are quite close. In addition, for other compare object samples, some identification rates K are lower than that of the target object sample while some are higher. The result is unideal.

Furthermore, in FIG. 3B, the peak wavelength of the first light-emitting element 11 is selected to be 940 nm and the peak wavelength of the second light-emitting element 12 is selected to be 1550 nm. According to the figure, it may be observed that the identification rates K for the orange and the human hand skin are still quite close. Nonetheless, the identification rates K for other compare object samples are obviously lower than that of the target object sample. If the accuracy requirement for object identification is loose, this combination of the first light-emitting element 11 and the second light-emitting element 12 is in fact practical.

Moreover, the preferred choice of the present example is shown in FIG. 3C, in which the peak wavelength of the first light-emitting element 11 is selected to be 1300 nm and the peak wavelength of the second light-emitting element 12 is selected to be 1550 nm. It is observed that the identification rates K of all compare object samples differ significantly from that of the target object sample. It means that if the combination the first light-emitting element 11 and the second light-emitting element 12 is selected, whether the approaching object 9 to the light sensor is human skin may be identified effectively.

In the following, some variations of the embodiments for the light sensor and the control method thereof according to the present application will be described. First, to identify if the object 9 approaching the light sensor is a specific object, the first light-emitting element 11 and the second light-emitting element 12 with different wavelengths as described above will suffice. Nonetheless, if a user has some more complicated identification requirements, for example, dividing the objects under test into several types, based on the previous embodiment, a third light-emitting element, a fourth light-emitting element . . . , etc. may be further disposed. By using these additional light emitting devices along with the first and second light-emitting elements 11, 12 corresponding to different wavelength ranges, the user may perform multiple identifications for different objects and hence judge more types of objects under test.

Furthermore, a person having ordinary skill in the art may understand the light sensing characteristics of the light-sensing element 21 for different wavelengths might be different. Thereby, if the difference between the wavelength ranges of the first light-emitting element 11 and the second light-emitting element 12 is large or the third light-emitting element or more light-emitting elements are adopted, it is difficult for a single light-sensing element to sense the light emitted by all light-emitting elements uniformly. A possible method is to adopt multiple light-sensing units to form the light-sensing element 21. The light-sensing characteristics of the multiple light-sensing units may correspond to the wavelengths of the plurality of light-emitting elements, respectively, for ensuring that the light emitted by each light-emitting element may be sensed by the light-sensing element after reflection.

According to the above embodiment, although the wavelength ranges of the light-emitting elements are different, they are roughly between 300 and 1600 nm. The wavelengths below 700 nm are visible light and suitable for applying to a location not influencing the visual appearance of products, for example, the backside of a smart watch.

In addition, to judge whether the type of an object is human skin according to the above example, the peak wavelength of the first wavelength of the first light-emitting element 11 is preferably between 1200 and 1400 nm; the peak wavelength of the second wavelength of the second light-emitting element 12 is preferably between 1450 and 1650 nm. Nonetheless, the light sensor and the control method thereof may be applied to many applications. The object to be judged is not limited to human skin. A person having ordinary skill in the art may determine the preferred ranges by experiments according to the description disclosed above. The details will not be described here.

To sum up, the light sensor and the control method thereof according to the present application comprise a plurality of light-emitting elements corresponding to different wavelength ranges. By controlling the operations of the plurality of light-emitting elements sequentially, the type of an object under test may be judged according to the difference between the signals sensed by a light-sensing element. By adopting the present application, a single light sensor is sufficient to judge the distance and the type of an object. In contrast, according to the prior art, additional capacitor sensors or temperature sensors are required to provide the type information. The present application significantly reduces the overall cost to accomplish the same functions of distance sensing and type identification required by electronic products.

The foregoing description is only embodiments of the present application, not used to limit the scope and range of the present application. Those equivalent changes or modifications made according to the shape, structure, feature, or spirit described in the claims of the present application are included in the appended claims of the present application.

1. A light sensor, comprising:
a first light-emitting element, generating a first emitting signal with wavelengths distributed within a first wavelength range;
a second light-emitting element, generating a second emitting signal with wavelengths distributed within a second wavelength range, said first wavelength range differing from the second wavelength range; and
a light-sensing element;
where a control circuit controls sequentially said first light-emitting element and said second light-emitting element to emit said first emitting signal and said second emitting signal; and
when said first emitting signal and said second emitting signal are reflected by an object and received by said light-sensing element, said control circuit judges the type of said object according to the signal sensed by said light-sensing element.

2. The light sensor of claim 1, wherein said first emitting signal is reflected by said object and forming a first reflection signal to be received by said light-sensing element; said second emitting signal is reflected by said object and forming a second reflection signal to be received by said light-sensing element; and said control circuit senses distance according to said first reflection signal or said second reflection signal sensed by said light-sensing element.

3. The light sensor of claim 1, wherein the peak wavelength of said first wavelength range is lower or higher than the peak wavelength of said second wavelength range.

4. The light sensor of claim 1, wherein said light-sensing element includes a plurality of light-sensing units; and the light-sensing characteristics of said plurality of light-sensing units correspond to said first wavelength range and said second wavelength range.

5. The light sensor of claim 1, wherein said control circuit is coupled to said first light-emitting element, said second light-emitting element, and said light-sensing element, respectively.

6. The light sensor of claim 1, wherein said light-sensing element and said control circuit are integrated on an integrated-circuit chip.

7. The light sensor of claim 2, wherein said control circuit produces an identification rate according to said first reflection signal and said second reflection signal sensed by said light-sensing element for judging the type of said object.

8. A control method of light sensor, controlling the operation of a light sensor, said light sensor comprising a first light-emitting element, a second light-emitting element, and a light-sensing element, said first light-emitting element emitting light with wavelengths corresponding a first wavelength range, said second light-emitting element emitting light with wavelengths corresponding a second wavelength range, said first wavelength range different from the second wavelength range, and comprising steps of:
a control circuit controlling sequentially said first light-emitting element and said second light-emitting element to emit light; and
said control circuit receiving the signal sensed by said light-sensing element;
where when the light emitted by said first light-emitting element and said second light-emitting element sequentially is reflected by an object and received by said light-sensing element, said control circuit judges the type of said object according to the signal sensed by said light-sensing element.

9. The control method of light sensor of claim 8, wherein the light emitted by said first light-emitting element is reflected by said object, forming a first reflection signal and received by said light-sensing element; the light emitted by said second light-emitting element is reflected by said object, forming a second reflection signal and received by said light-sensing element; and said control circuit senses distance according to said first reflection signal or said second reflection signal sensed by said light-sensing element.

10. The control method of light sensor of claim 8, wherein the peak wavelength of said first wavelength range is lower or higher than the peak wavelength of said second wavelength range.

11. The control method of light sensor of claim 8, wherein said control circuit controls said first light-emitting element and said second light-emitting element to emit light sequentially or said second light-emitting element and said first light-emitting element to emit light sequentially.

12. The control method of light sensor of claim 9, wherein said control circuit produces an identification rate according to said first reflection signal and said second reflection signal sensed by said light-sensing element for judging the type of said object.
